(19) United States
(12) Patent Application Publication
(10) Pub. No.: US 2010/0023510 A1
(43) Pub. Date: Jan. 28, 2010

(54) TERMINAL DEVICE AND SYSTEM FOR SEARCHING PERSONAL INFORMATION

(76) Inventors: Norihiko Naono, Tokyo (JP); Kunihiko Ohnaka, Tokyo (JP); Mitsutaka Okazaki, Tokyo (JP); Tomohisa Ota, Tokyo (JP)

Correspondence Address: WINSTON & STRAWN LLP;PATENT DEPARTMENT, 1700 K STREET, N.W., WASHINGTON, DC, 20006, US

(21) Appl. No.: 12/506,669

(22) Filed: Jul. 21, 2009

(30) Foreign Application Priority Data
Jul. 23, 2008 (JP) P2008-190070

(51) Int. Cl. G06F 17/30; G06F 15/16

(52) U.S. Cl. 707/5; 707/102; 709/203; 707/3; 707/E17.014; 707/E17.045

(57) ABSTRACT

An information terminal of a user B who permits a user A to search the person B calculates a calculation result G(Pa′, Pb) by using information Pa′ related to the user A and information Pb of the user B, both Pa′ and Pb being stored in the information terminal of the user B and transmits to a server the calculation result G(Pa′, Pb). Further, the information terminal of the user B receives trust information expressing that Pb is authenticated and calculates a calculation result F(Pb) and transmits to the server. The information terminal of the user A calculates G(Pa, Pb′) and transmits it to the server. When the server receives G(Pa, Pb′) from the information terminal of the user A, the server searches G(Pa′, Pb) which matches G(Pa, Pb′) and the search result with F(Pb) to the information terminal of the user A. The information terminal of the user A calculates F(Pb′) and compares it with F(Pb) which is sent by the server.

### CROSS REFERENCE TO RELATED APPLICATION

This application is based upon and claims the benefit of priority from the prior Japanese Patent Application No. 2008-190070, filed on Jul. 23, 2008, the entire contents of which are incorporated herein by reference.

### BACKGROUND OF THE INVENTION

1. Field of the Invention

The present invention is generally related to a search technology prior to the establishment of communication on a network. More specifically, it is related to a method, an information terminal, and a system in which a user can restrict the scope of persons who can search the user in order to communicate with the user.

2. Description of the Related Art

Until recently, the internet was used to disclose information to unspecified users through a server such as a WEB server, or through a Peer-to-Peer (P2P) network. Whereas recently, services to exchange personal information so that the information to be exchanged is disclosed to a specified user on the internet are increasing. An IP phone, a network game or a social network site (SNS), etc. are good examples. In these services, it is preferable to restrict other persons who can reach personal information. In the case of an IP phone, for example, it is necessary to specify a user to which his/her telephone numbers are disclosed in order to prevent nuisance calls.

Moreover, various consumer products such as digital cameras, video cameras, portable audio players, video recorders, navigation systems etc. are increasingly connected to the IP network. It is expected that in future these consumer products will be used as information terminals for communication between individuals.

In order to communicate with specified persons or exchange data by using various information terminals connected to a network, the user must search and specify uniquely the acquaintance on the network with whom he/she wishes to communicate.

In most of the services, the communication between individuals or the exchange of data is executed on an administration server of a service provider. First, a user receives authentication by logging in at his/her information terminal to the server. While searching the acquaintance to be communicated with, information disclosed and registered in advance by that acquaintance in the server of the service provider is directly searched. If it is possible to specify that acquaintance uniquely through the search, the terminal of the user obtains an ID from the service provider server to identify the acquaintance uniquely on the service.

Moreover, there is a service such as a Peer-to-Peer (P2P) where the architecture that does not depend on the specific server is used. In such a service, a query must be submitted to a node (an adjacent node) for direct communication in order to search the individual information disclosed to the participants of the service by that acquaintance. When the individual information, which is a search target of the query, does not exist in the adjacent node, the query is forwarded to another adjacent node. The query is repetitively forwarded to other nodes until the node having the targeted individual information is found. If the query is forwarded to an adequate node, the terminal of the user obtains an ID for identifying the acquaintance on the service from the adequate node.

FIG. 1 explains a typical search on a server client system under a prior art. In the system shown in FIG. 1, the following steps must be executed by a user A and a user B so that the user A, who is the searcher, can communicate with B, who is an acquaintance to be searched, in order for the user A to communicate with the user B using a terminal 110 and a server 100. In Step 1, the user B sends from the terminal 120 of the user B to the server 100 the information necessary for other users to search the user B on the network, and the information is stored in a storage device 103 of the server 100. In Step 2, the user A requests from the terminal 110 of the user A to the server 100 the information of the user B stored in the storage device 103 of server 100 in Step 1 above. In Step 3, the search is performed in the storage device 103 in response to the request in Step 2 above by the search device 102 of the server 100 and if the information of the user B, which is stored in Step 1, is found, an identification tag for uniquely identifying the user B is sent from the server 100 to the terminal 110 of the user A.

### BRIEF SUMMARY OF THE INVENTION

The inventors of the present invention have found five problems in the prior art as listed below.

The first problem is that there is no means where the person who is to be searched (the user B in the aforementioned example) can restrict the scope of the searcher in advance. Not only the user A, but also another user X who is a third person can search the information of the user B registered in the server 100 in Step 1. While the user B may think that “I would like to be searched by the user A, but the user X is barred from searching,” this can not be realized in the prior art. For example, the actual name of the person who is to be searched should be registered in an existing SNS service to enable a search by an acquaintance. However, in an SNS service, where a search by using the prior art is used, there is no means to prevent a search by a malicious third person. For this reason, most of the users of an SNS service only register anonymous information and hence it becomes difficult for the group of acquaintances to search their acquaintance mutually.

The second problem is, in many cases, a searcher often obtains unnecessary multiple search results. In many services, it is difficult for a user to register information for identifying him/her uniquely on the network in the storage device 103 of the server in the aforementioned Step 1. For example, in an SNS service, each user often registers their respective nickname for search. However, in such cases, the same nickname may be frequently registered by multiple users, hence when a searcher tries to search an acquaintance by their nickname, multiple match cases are reported from the server to the terminal. In such a case, a searcher can not identify the intended person who is to be searched.

The third problem is that the service provider can access the information of all persons who are to be searched. An administrator of the server 100 can access the information registered, in Step 1 above, in the storage device 103 of the server by the user B who is to be searched. As a result, the information registered by all users is concentrated at the administrator of the server.

The fourth problem is that each user must actively register his/her information and actively execute a search. In other words, the user A can not identify the user B if any one of the above mentioned three steps is skipped. For example, the user A, who is a searcher, can not obtain the information of the user B unless the user A actively submits a query to the server 100. Moreover, the information of the user B has to be registered to the server 100 prior to the search.

As an example, suppose that the user B registers his/her own name in the server 100 and the user A enquires for the name of the user B known to him/her. The user A, who is an original searcher, cannot search the user B unless he/she enquires the name of the user B to the server 100 by executing a search operation. Even though the search operation is executed by the user A, the search is not successfully executed unless the enquired name matches with the information already registered in the server 100 by the user B. This is a major drawback in various network services, including an SNS, which deteriorate the user-friendliness.

The fifth problem is that there is no means for preventing spoofing of a person, who is to be searched, by a malicious third person. For example, suppose that a malicious third person X happens to get the information related to the user B and the user X registered this information related to the user B as information related to the user X to the storage device 130 of the server from the information terminal 130. In this case, in the aforementioned Step 2, when the terminal 110 of the user A submits a query to search the user B, the search device 102 may return the aforementioned information related to the user X to the terminal 110 of the user A as a search result. For example, in an SNS service, the searcher can not confirm the identity of the person who is searched, when the person who is searched registers the name of the other person for search. Therefore, there is a risk of spoofing by a malicious third person in the prior art.

One of objectives of the present invention is to solve the problems related to a search in the prior art so that a person can restrict the scope of searchers that can search himself/herself in advance and so that there can be very few cases where multiple search results are obtained. Moreover, the person who is to be searched should not disclose his/her information even to the service provider of the server, and, further, if an explicit search is not executed, an acquaintance can be searched safely on the network. Additionally, it is also one of objectives of the present invention to provide a technology where spoofing can be effectively eliminated by a malicious third person.

An embodiment of the present invention provides an information terminal which includes a storage device which stores information Pb related to an owner of the information terminal and information Pa′ related to a user different from the owner; a calculation device for calculating a calculation result G(Pa′, Pb) by applying a calculation G to the information Pb and the information Pa′ stored in the storage device; and a transmitting device which transmits the calculation result G(Pa′, Pb) to a server.

An embodiment of the present invention provides an information terminal which includes a calculation device for calculating a calculation result F(Pb) by applying a calculation F to the information Pb related to an owner of the information terminal and stored in the information terminal; a receiving device which receives trust information which expresses that the information Pb is related to the owner of the information terminal is authenticated; and a transmitting device which transmits the calculation result F(Pb) to a server when the receiving device receives the trust information.

An embodiment of the present invention provides an information terminal which includes a storage device which stores information Pa relating to an owner of the information terminal and information Pb′ relating to a user different from the owner; a first calculation device for calculating a calculation result G(Pb′, Pa) by applying a calculation G on the information Pa and the information Pb′ stored in the storage device; a second calculation device for calculating a calculation result F(Pb′) by applying a calculation F to the information Pb′; and a table creation device for correlating the calculation result G(Pb′, Pa) with the calculation result F(Pb′).

An embodiment of the present invention provides a server which comprises a receiving device which receives from an information terminal of a user B a calculation result G (Pa′, Pb), which is calculated by applying a calculation G to information Pb relating to user B stored in the information terminal of the user B, and information Pa′ relating to a user A, the information Pa′ being stored in the information terminal of user B; and a table creation device for correlating the calculation result G (Pa′, Pb) with an identification tag Xb for uniquely specifying the user B.

An embodiment of the present invention provides a server which comprises a first receiving device which receives trust information which expresses that information Pb stored in an information terminal is authenticated to be information to an owner of the information terminal; a second receiving device which receives a calculation result F(Pb) calculated by applying a calculation F to Pb stored in the information terminal and transmitted to the server by the information terminal, on the reception of the trust information by the first receiving device; and a table creation device which stores an identification tag Xb for uniquely specifying user B and the calculation result F(Pb) and correlates F(Pb) with Xb.

An embodiment of the present invention provides a server which includes a first receiving device which receives a calculation result G(Pa′, Pa) from an information terminal of a user B, the calculation result being calculated by applying a calculation G to information Pb relating to the user B and information Pa′ relating to a user A stored in the information terminal of the user B; a first table creation device which stores an identification tag Xb for uniquely specifying the user B and the calculation result G(Pa′, Pb) in a first table and correlating G(Pa′, Pb) with Xb; a second receiving device which receives trust information from the information terminal of the user B, the trust information showing that the information Pb stored in the information terminal of the user B belongs to the user B is authenticated; a third receiving device which receives a calculation result F(Pb) transmitted after the second receiving device receives the trust information; and a second table creation device which stores the identification tag Xb for uniquely specifying user B and the calculation result F(Pb) in a second table and correlates F(Pb) with Xb.

An embodiment of the present invention provides an information terminal which includes a transmitting device which transmits an identification tag Xb for uniquely specifying a user B to a server, the user B being different from an owner of the information terminal; a first receiving device which receives trust information which expresses that information Pb stored in the information terminal of the user B is authenticated as information relating to the user B; and a second receiving device which receives via the server a transmitted calculation result F(Pb) calculated by applying a calculation F to the information Pb, when the first receiving device receives the trust information.

An embodiment of the present invention provides a system which includes an information terminal of a user A which stores information Pa relating to the user A and information Pb′ relating to a user B; an information terminal of a user B which stores information Pa′ relating to the user A and information Pb relating to the user B; and a server; wherein the information terminal of the user B comprises: a first transmitting device which transmits a first calculation result G(Pb, Pa′) to the server; the first calculation result being calculated by applying a calculation G to the information Pa′ of the user A and the information Pb of the user B; wherein the information terminal of the user A comprises: a second transmitting device which transmits a second calculation result G(Pb′, Pa) to the server, the second calculation result being calculated by applying a calculation G to the information Pa of the user A and the information Pb′ of the user B; and wherein the server includes: a storage device which stores the first calculation result G(Pb, Pa′) and an identification tag Xb of the user B and correlates G(Pb, Pa′) with Xb; a third transmitting device which transmits the identification tag Xb of the user B to the information terminal of the user A when the identification tag Xb of the user B is detected to be correlated with the first calculation result G(Pb, Pa′) by searching for a calculation result which matches with the second calculation result G(Pb′ Pa) and detecting a match between the first calculation result G (Pb, Pa′) and the second calculation result G (Pb′, Pa).

An embodiment of the present invention provides a system which includes an information terminal of a user B which stored information Pb of the user B; and a server; wherein the information terminal of the user B includes: a receiving device which receives trust information which expresses that the information Pb stored by the information terminal of the user B belongs to the user B is authenticated; and a transmitting device which generates a calculation result F(Pb) by applying a calculation F to the information Pb stored in the information terminal of the user B and transmits the calculation result F(Pb) to the server when the receiving device receives the trust information; and the server includes a storage device which stores the calculation result F(Pb) and an identification tag Xb of the user B and correlates F(Pb) with Xb.

An embodiment of the present invention provides a system which includes an information terminal of a user A which stores information Pa relating to the user A and information Pb′ relating to a user B; an information terminal of the user B which stores information Pa′ relating to the user A and information Pb relating to the user B; and a server; wherein the information terminal of a user B includes: a receiving device which receives trust information which expresses that the information Pb belongs to user B is authenticated; a first transmitting device which generates a first calculation result F(Pb) by applying a calculation F to the information Pb and transmits the first calculation result F(Pb) to the server when the receiving device receives the trust information; and a second transmitting device which generates a second calculation result G(Pb, Pa′) by applying a calculation G on the information Pa′ relating to the user A and the information Pb relating the user B; wherein the information terminal of user A includes: a third transmitting device which generates a third calculation result G(Pb′, Pa) which is calculated by applying a calculation G on the information Pa relating to the user A and the information Pb′ relating to the user B and transmits the third calculation result to the server; wherein the server includes: a first storage device which stores in a first table the first calculation result F(Pb) and an identification tag Xb of the user B and correlates F(Pb) with Xb; a second storage device which stores in a second table the second calculation result G(Pb, Pa′) and the identification tag Xb of the user B and correlates G(Pb), Pa′) with Xb; a search device which searches the second table for a calculation result which matches the third calculation result by detecting a match between the second calculation result G(Pb, Pa′) and the third calculation result G(Pb′, Pa), detecting the identification tag Xb correlated with the second calculation result, searching the first table for the identification tag Xb as a search key and detecting the first calculation result F(Pb); and a transmitting device which transmits the first calculation result F (Pb) to the information terminal of user A.

An embodiment of the present invention provides a system which includes an information terminal of a user A which stores information Pa relating to the user A and information Pb′ relating to a user B; an information terminal of the user B which stores information Pa′ relating to the user A and information Pb relating to the user B; and a server; wherein the information terminal of the user B includes: a first transmitting device which generates a first calculation result G(Pb, Pa′) which is calculated by applying a calculation G on the information Pa′ and the information Pb and transmits the first calculation result to the server; a second transmitting device which generates a second calculation result G(Pa′, Pb) which is calculated by applying the calculation G on the information Pa′ and the information Pb and transmits the second calculation result to the server; a first receiving device which receives first trust information which expresses that the information Pb belongs to user B is authenticated; and a third transmitting device which transmits a third calculation result F (Pb) to the server when the first receiving device receives the first trust information; wherein the information terminal of the user A includes: a fourth transmitting device which generates a fourth calculation result G(Pa, Pb′) which is calculated by applying the calculation G on the information Pb′ and the information Pa and transmits the second calculation result to the server; a fifth transmitting device which generates a fifth calculation result G(Pb′, Pa) which is calculated by applying the calculation G on the information Pa and the information Pb′ and transmits the fifth calculation result G(Pb′, Pa) to the server; a second receiving device which receives second trust information which expresses that the information Pa belongs to user A is authenticated; a sixth transmitting device which transmits a sixth calculation result F(Pa) to the server when the second receiving device receives the second trust information; wherein the server includes: a first storage device which stores in a first table an identification tag Xb of the user B and the first calculation result G(Pb, Pa′), correlates G(Pb, Pa′) and Xb, stores in the first table an identification tag Xa of the user A and the fourth calculation result G(Pa, Pb′), and correlates G(Pa, Pb′) with Xa; a detection device which searches the first table for the fifth calculation result G (Pb′, Pa) as a search key, detects a match with the first calculation result G (Pb, Pa′), detects the identification tag Xa of the user A correlated with the first calculation result G (Pb, Pa′) in the first table, searches the first table for the second calculation result G (Pa′, Pb) as a search key, detects a match with the fourth calculation result G (Pa, Pb′), and detects the identification tag Xb of the user B correlated with the first calculation result G (Pb, Pa′) in the first table; a correlating device which stores the sixth calculation result F(Pa) and the identification tag Xa of the user A, correlates F(Pa) with Xa, stores the third calculation result F(Pb) and the identification tag Xb of the user B, and correlates F(Pb) with Xb.

### BRIEF DESCRIPTION OF THE DRAWINGS

FIG. 1 is a diagram for explaining a prior art.

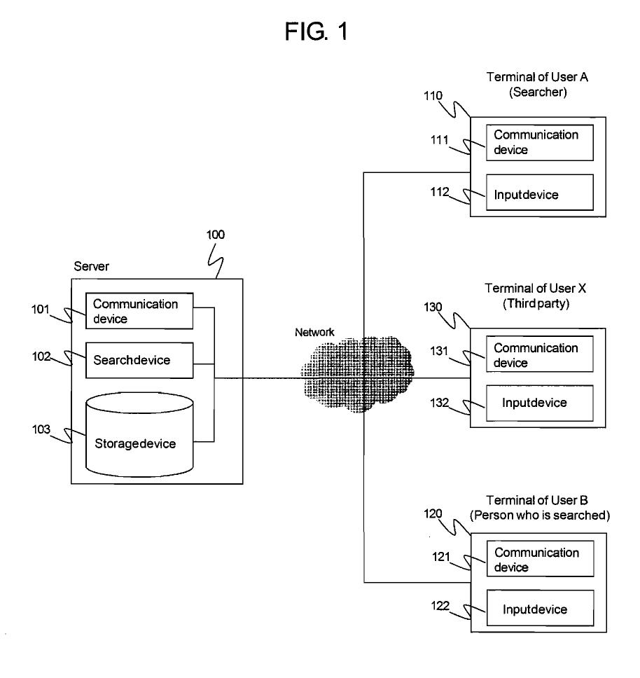

FIG. 2 is a structural diagram of an information terminal and a server in one embodiment of the present invention.

FIG. 3 is a structural diagram of a server in one embodiment of the present invention.

FIG. 4 is a structural diagram of an information terminal in one embodiment of the present invention.

FIG. 5 is a structural diagram of an information terminal in one embodiment of the present invention.

FIG. 6 is a diagram for explaining a process whereby the information that an information terminal is authenticated is registered in a server in one embodiment of the present invention.

FIG. 7 is an exemplary diagram of an identification table in a server in one embodiment of the present invention.

FIG. 8 is a diagram for explaining a process whereby a searcher searches for a user and the search result is confirmed as being authenticated in one embodiment of the present invention.

FIG. 9 is an exemplary diagram of a search table in a server in one embodiment of the present invention.

FIG. 10 is an exemplary diagram of a searcher table in an information terminal in one embodiment of the present invention.

FIG. 11 is a diagram for explaining a process whereby an information terminal is searched in one embodiment of the present invention.

FIG. 12 is a diagram for explaining a process whereby an information terminal is searched in one embodiment of the present invention.

FIG. 13 is an exemplary diagram of a search table in a server in one embodiment of the present invention.

FIG. 14 is a diagram for explaining a process whereby a pair of information terminals perform a mutual search in one embodiment of the present invention.

FIG. 15 is a diagram for explaining an authentication process after a pair of information terminals perform a mutual search in one embodiment of the present invention.

FIG. 16 is an exemplary diagram of a self authentication table in an information terminal in one embodiment of the present invention.

### DETAILED DESCRIPTION OF THE INVENTION

An explanation of embodiments in order to carry out the present invention is given below. Since the scope of the present invention is specifically defined by the scope of the claims, the explanation below should not be interpreted to be a restrictive meaning but to be an explanation of the general principles of the present invention by examples.

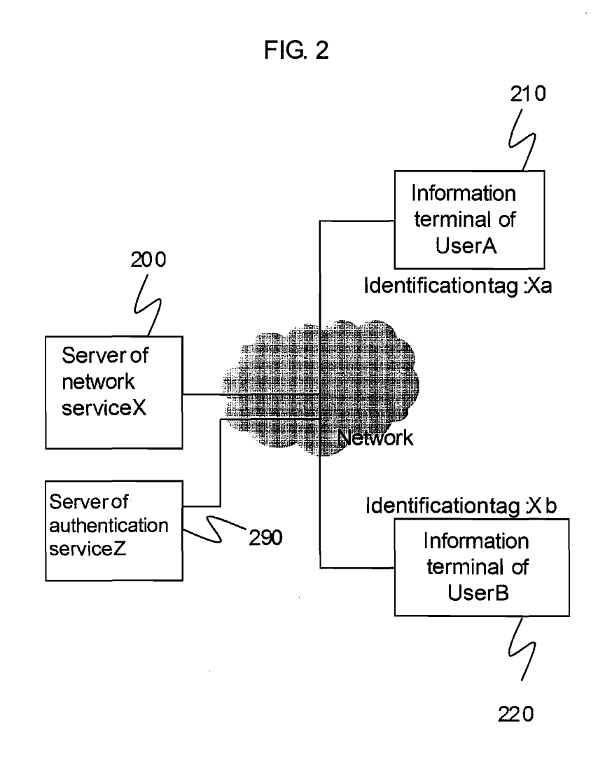

An example of an embodiment of the present invention is shown in FIG. 2. An information terminal 210 of a user A and an informational terminal 220 of a user B are connected with the server 200 of a network service X via a network. In addition, the server 290 of an authentication service Z, which is used during to authenticate the user A and the user B via each information terminal, is also connected with the information terminal 210 of the user A and the information terminal 220 of the user B through the network. The authentication service may be implemented by a server other than the server 200 of the network service X as shown in FIG. 2 or it may be implemented by using some applications of the server 200 of the network service X.

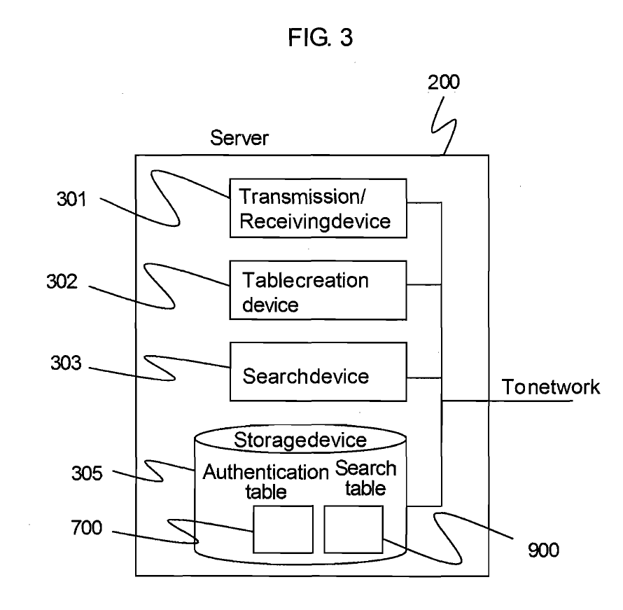

FIG. 3 shows a schematic configuration diagram of the server 200 of the network service X related to one embodiment of the present invention. The server 200 includes a transmission/reception device 301, a table creation device 302, a search device 303, and a storage device 305. The storage device includes an authentication table 700 and a search table 900.

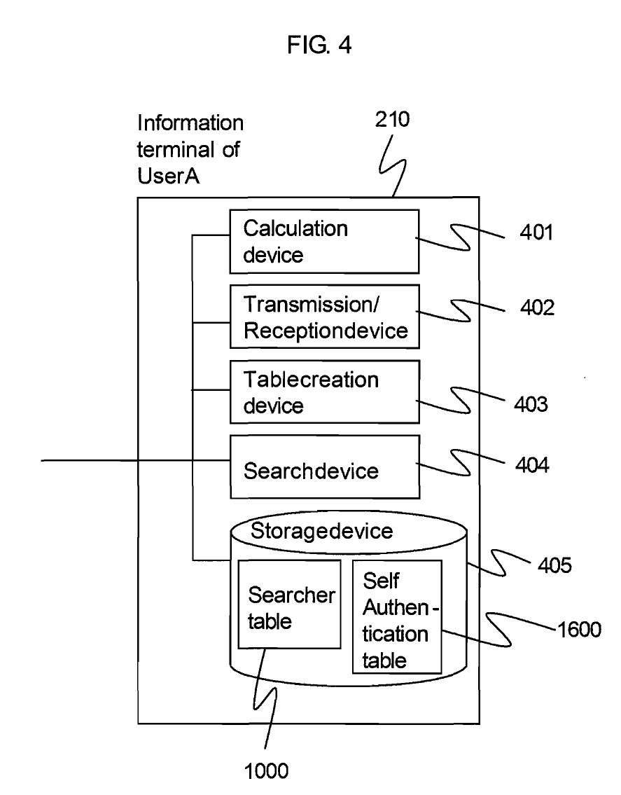

FIG. 4 shows a schematic configuration diagram of the information terminal 210 of the user A related to one embodiment of the present invention. The information terminal 210 of the user A includes a calculation device 401, a transmission/reception device 402, a table creation device 403, a search device 404, and a storage device 405. The storage device 405 includes tables called a searcher table 1000 and a self authentication table 1600.

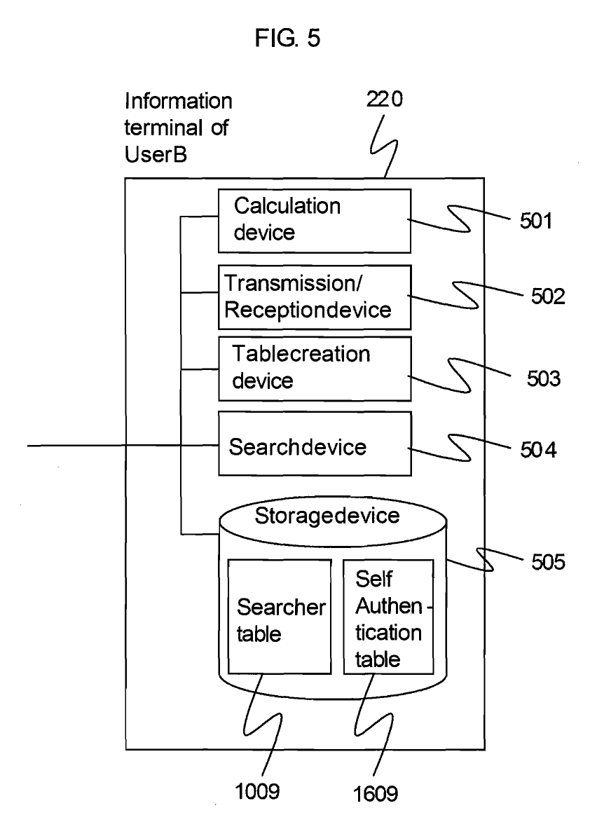

FIG. 5 shows a schematic configuration diagram of the information terminal 220 of the user B related to one embodiment of the present invention. The information terminal 220 of the user B includes a calculation device 501, a transmission/reception device 502, a table creation device 503, a search device 504, and a storage device 505. The storage device 505 includes tables called a searcher table 1009 and a self authentication table 1609.

Here, a notation without a prime (′) at its upper right side (for example, Pa or Pb) denotes the information stored in an information terminal and related to an owner of the information terminal. For example, Pa denotes the information stored in the storage device 405 of the information terminal 210 of the user A and related to the user A, who is the owner of the information terminal 210 of the user A. Similarly, Pb denotes the information stored in the storage device 505 of the information terminal 220 of the user B and related to the user B, who is the owner of the information terminal 220 of the user B. On the other hand, a notation with a prime (′) at its upper right side denotes the information stored in an information terminal and related to a user other than the owner of the information terminal. For example, Pb′ denotes the information stored in the storage device 405 of the information terminal 210 of the user A and related to the user B, who is not an owner of the information terminal 210 of the user A. And, Pa′ denotes the information stored in the storage device 505 of the information terminal 220 of the user B and related to the user A, who is not an owner of the information terminal 220 of the user B.

Information Pa related to the user A may be any information for identifying the user A itself such as a name, an e-mail address, a telephone number, an address, an optional network service ID (identification), or address information etc. Similarly, information Pb related to the user B may be any information for identifying the user B itself such as a name, an e-mail address, a telephone number, an address, an optional network service ID (identification), or address information etc.

When the information stored in the storage device 405 of the information terminal of the User A and the information stored in the storage device 505 of the information terminal of the User B is correct, then the equations Pa=Pa′ and Pb=Pb′ hold. But, if there is any mistake in information, then it is not necessarily that such equations hold. For example, when the information Pa′ related to the user A in the information terminal of the user B is wrong, it may be the case that Pa=Pa′ does not hold.

Further, in the embodiment one explained below, it is assumed that the user A searches for the user B, and the information terminal of the user A starts the communication after receiving an identification tag Xb of the user B from the server X as a result of the search. And in the embodiment two, which follows the embodiment one, it is assumed that the user A and the user B search for each other, and the communication between the user A and the user B starts after the information terminal of the user A receives the identification tag Xb of the user B from the server X as a result of the search by the user A and the information terminal of the user B receives an identification tag Xa of the user A from the server X as a result of the search by the user B. One of the major differences between the embodiment one and the embodiment two is that information Pb is authenticated prior to a search in the embodiment one and on the contrary, information Pa and Pb may be authenticated after a search by the user A and the user B in the embodiment two.

### Embodiment One

In the embodiment one of the present invention, when the user A searches for the user B, first of all, the user B receives an authentication information of the information Pb, which is related to user B itself and which is stored in its information terminal 220, from authentication server 290 of the authentication service Z. Next, the information terminal 220 of the user B registers the fact that the information Pb is authenticated into the authentication table 700 of the server X so that the authentication information of the information Pb is correlated with the identification tag Xb of the user B. After that, by using the information Pb, which is authenticated, the user A, who is searching for the user B, registers the information required for searching for the user B, who is the person to be searched, in the search table 900 of the server X so that the information required for searching for the user B is correlated with the identification tag Xb of the user B. Then, the user A searches for the user B by using the information Pb′ related to the user B which is stored in the information terminal 210 of the user A and then obtains the identification tag Xb of the user B as a result of the search. According to the method of the present embodiment of the present invention, the user A can be aware that the information Pb′ related to user B stored in the information terminal 210 owned by the user A is correct and that the information Pb is information related to user B and is authenticated by the authentication service Z and after that the user A can start a communication with user B by using the identification tag Xb.

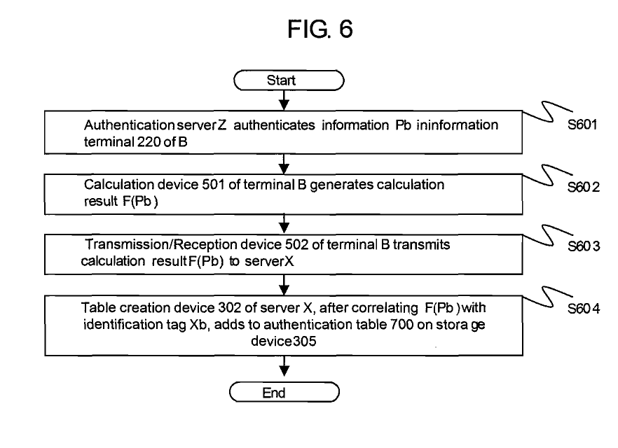

With reference to FIG. 6, an example of a process for registering the fact that the information Pb, which is stored in the information terminal 220, is really information related to the user B into the authentication table 700 of the server X is explained.

First of all, the server 290 of the authentication service Z authenticates by using a certain method that the information Pb of the user B, which is stored in the information terminal 220, is the information related to user B, who is to be the person to be searched (Step S601). Here, the authentication method and/or the level of the authentication is not limited to one.

An example of an authentication method of the information Pb by the authentication service Z is given as follows. The user B informs an employee of the provider of the authentication service Z in advance of the information such as a password etc., which is unknown to a third party. Then, the employee of the provider of the authentication service Z registers the information, which is obtained from the user B and which is unknown to the aforementioned third party, into the storage device of server 290. At the time of the authentication of the information terminal 220, the provider of the authentication service Z asks the user B via the information terminal 220 about the information, which is unknown to the third party, and the user B inputs or replies the information as an answer, which is unknown to the aforementioned third party to the server 290 via the information terminal 220. If the answer is in accordance with the information already registered in the server 290 and which is unknown to the aforementioned third party, then it is authenticated that user B is the actual owner of the information terminal 220. This is an example of a so called a high-assurance authentication on the basis of the face to face identification verification.

As another example of the authentication methods, an authentication by e-mail or by CAPTCHA (Completely Automated Public Turing test to tell Computers and Humans Apart) may be used. In the authentication by e-mail, the information terminal 220 transmits the e-mail address by which the user B can receive e-mails at the information terminal 220 to the server 290 of the authentication service Z, then the server 290 transmits the password to that e-mail address and after that the user B replies the password contained in the e-mail to the server 290. In the authentication by CAPTHCA, text information which is legible to humans but illegible to computers is transmitted to the information terminal 220 from the server 290 and then the user B transmits that text information to the server 290 after typing or entering it in the information terminal 220. In the authentication by e-mail or CAPTCHA, the identity of the user B is not directly authenticated unlike the so-called high level assurance, but it only confirms that the information terminal 220 is operated by a human. Such a confirmation is called a Turing test. However, it is used as an authentication method in various network services because of its low cost. These are the examples of authentication methods in Step S601. However, any authentication method can be used irrespective of authentication levels.

Next, the calculation device 501 of the information terminal of the user B, who is to be searched, applies an arbitrary calculation F to the information Pb, which is related to the user B and which is authenticated by the server 290 of the authentication service Z, and creates the calculation result F(Pb) (Step S602). In the following, the calculation F is assumed to be an irreversible calculation, although the calculation F may be a reversible calculation.

After that, the transmission/reception device 502 of the information terminal 220 of the user B, who is to be searched, transmits the aforementioned calculation result F(Pb) to the server 200 via the network in order to register F(Pb) (Step S603). F(Pb) is received by the transmission/reception device 301 of the server 200 of the network service X. Then, the table creation device 302 inserts this calculation result F(Pb) into the authentication table 700 so that F(Pb) is correlated with the identification tag Xb for identifying user B uniquely on the network service X (Step S604). The fact that calculation result F(Pb) is stored in the authentication table 700 indicates that the information, which is information originated from the user B and which is stored in the information terminal 220, is authenticated by the authentication service Z.

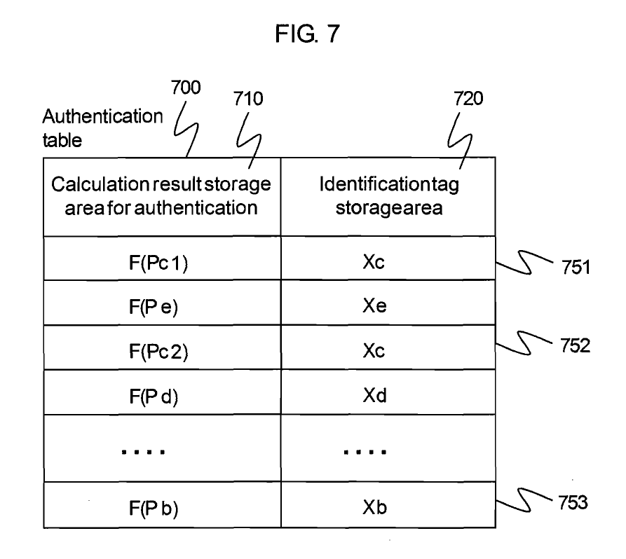

FIG. 7 shows an example of the authentication table 700. The authentication table in the storage device 305 includes a storage area 710 for storing a calculation result for authentication and a storage area 720 for storing an identification tag. The server 200 stores a calculation result which the server 200 receives so that the calculation result is correlated with an identification tag, which is transmitted from an information terminal to the server 200, of a user of the information terminal. For example, as shown in FIG. 7, the calculation result F(Pc1) for authentication received by the server 200 from the terminal of the user C having an identification tag Xc is correlated with the identification tag Xc stored in the column of the reference numeral 751. Moreover, the calculation result F(Pc2) for a different authentication received by the server 200 from the terminal of the user C having the same identification tag Xc is correlated with the identification tag Xc stored in the column of the reference numeral 752. In the present embodiment, the calculation result F(Pb) for authentication received by the server 200 from the information terminal of the user B having the identification tag Xb is stored in the authentication table so that F(Pb) is correlated with the identification tag Xb stored in the column of the reference numeral 753.

Further, the aforementioned identification tag Xb may be received from the information terminal 220 of the user B or may be created by the server 200. In the former case, the calculation device 503 of the information terminal of the user B correlates the calculation result F (Pb) with the identification tag Xb of the user B and the transmission/reception device 502 transmits it to the server 200. After that, the table creation device inserts it to the column of the reference numeral 753 in the authentication table. In the latter case, the transmission/reception device 502 of the information terminal of the user B transmits the calculation result (Pb) to the server 200 and the table creation device of the server correlates it with the stored or generated identification tag Xb of the user B in the authentication table as the column of the reference numeral 753.

The process comprising steps from Step S601 to Step S604 is one of methods to register the fact that the information Pb is stored in the information terminal 220 of user B into the authentication table 700 of the server X. In the present embodiment, when the fact that the information Pb is stored in information terminal 220 of the user B by using the above stated method is registered in the authentication table 700 of the server X, the user B, who is to be searched, can notify to any searcher that there is no spoofing by a third party with respect to the user B.

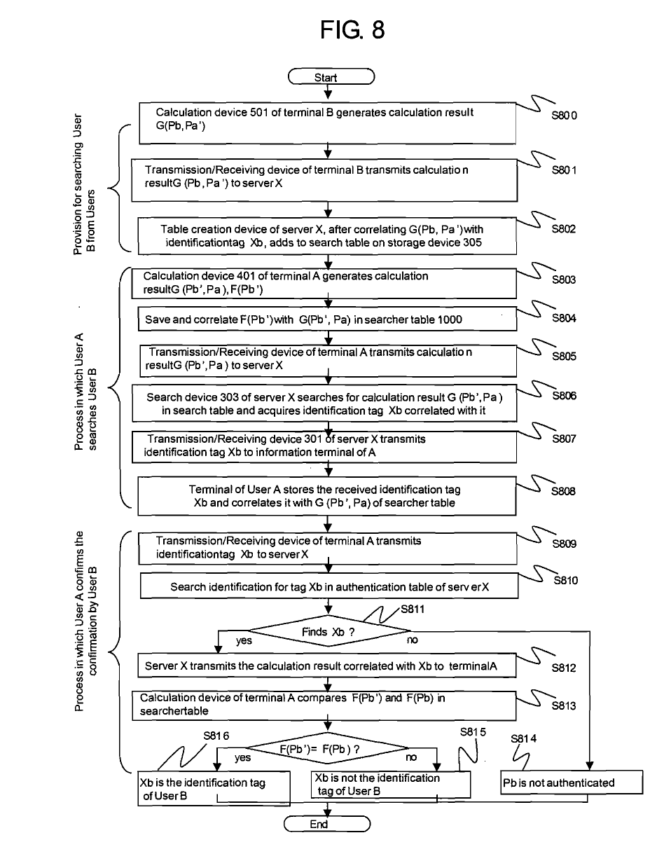

Next, with reference to FIG. 8, a process is described in which the user A starts a communication with the information terminal 220 of the user B after the user A searches for the user B by using the information Pb′ related to the user B which is stored in the information terminal 210, receives the identification tag Xb for identifying the user B uniquely, and further obtains the fact that Pb, which is stored in the information terminal 220 of the user B, is authenticated to be the information related to the user B by the server Z (for example, a server of the authentication service Z).

The calculation device 501 of the information terminal 220 of user B, who is to be searched, applies a calculation G, which may be any calculation, on the information Pb related to the user B and the information Pa′ related to user A stored in the storage device 505 and generates the calculation result G(Pb, Pa′) (Step S800). Here, the calculation G may be reversible or irreversible. In the description below concerning the present embodiment, the calculation G is assumed to be non-commutative and irreversible. As an example of a non-commutative and irreversible calculation, there is an operation to calculate a hash after concatenating character strings. However, here the calculation G may be commutative or non-commutative. In the example shown in the present embodiment, a non-commutative calculation is used and the information Pb related to the person who is to be searched is given as the first argument of the calculation G and the information Pa′ related to the searcher is given as the second argument to the calculation G, but it may be in reverse order. Moreover, Pb and Pa′, which are given as arguments to the calculation G, do not have to be information of the same attributes. For example, Pb can be a name of the user B, and Pa′ can be an e-mail address of the user A. Moreover, the aforementioned calculations F and G may be the same calculations or different calculations.

Next, the transmission/reception device 502 of the information terminal 220 of the user B, who is to be searched, transmits the aforementioned calculation result G (Pb, Pa′) via the network to the server X 200 (Step S801). The calculation result G (Pb, Pa′) is received by the transmission/reception device 301 of the server 200 of the network service X. Then, the table creation device 302 inserts the calculation result G (Pb, Pa′) into the search table 900 so that G (Pb, Pa′) is correlated with the identification tag Xb for identifying the user B uniquely on the network service X (Step S802).

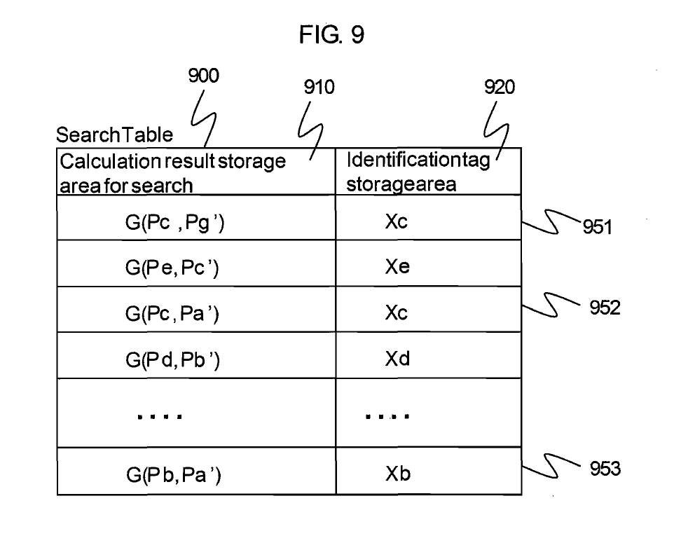

FIG. 9 shows an example of the search table 900. The search table in the storage device includes a storage area 910 for a calculation result for search and a storage area 920 for an identification tag. A calculation result for search which the server 200 receives is stored so that the calculation result for search is correlated with an identification tag of a user of an information terminal which transmitted the calculation result to the server 200. In one example shown in FIG. 9, the calculation result G (Pc, Pg′) for search, which is received by the server 200 from the information terminal of the user C, is correlated with the identification tag Xc (the column of the reference numeral 951). Moreover, the calculation result G (Pc, Pa′) for a different search, which is received by server 200 from the information terminal of the user C having the same Identification tag Xc is correlated with the identification tag Xc (the column of reference numeral 952). For example, the calculation result G(Pc, Pg′) for search is sent to the server 200 after creating the calculation result G(Pc, Pg′) from the information Pc related to the user C and the information Pg′ related to the user G as arguments of the calculation G at the information terminal of the user C. Thus it may be considered a fact that the user C permits the user G to search the user C is registered in the server. In this embodiment, the calculation result G(Pb, Pa′) for search received by the server 200 from the information terminal of the user B having the identification tag Xb is stored in this search table so that G(Pb, Pa′) is correlated with the identification tag Xb (the column of reference numeral 953).

Further, the aforementioned identification tag Xb may be received from the information terminal 220 of the user B or may be stored or generated by the server 200. In the former case, the calculation device 503 of the information terminal of the user B correlates the identification tag Xb of the user B with the calculation result G (Pb, Pa′) and then the transmission/reception device 502 transmits it to the server 200. Moreover, the table creation device 302 of the server inserts this tag into the search table (column of symbol 953). In the latter case, the transmission/reception device 502 of the information terminal of the user B transmits the calculation result G (Pb, Pa′) to the server 200 and then it correlates the identification tag Xb of the user B, which is stored in advance or created by using the table creation device of the server, with this calculation result G (Pb, Pa′) and then inserts it into the authentication table (column of numeral 953).

According to the prior art, it is not possible for the user B to restrict users who can search the user B at the time when the user B registers the information of himself/herself in the server. However, according to the present embodiment of the present invention, when the user B transmits the aforementioned calculation result G (Pb, Pa′) to the server 200, the user B restricts the scope of users who can search the user B as the scope of the users whose information terminals store the information Pb′ related to the user B.

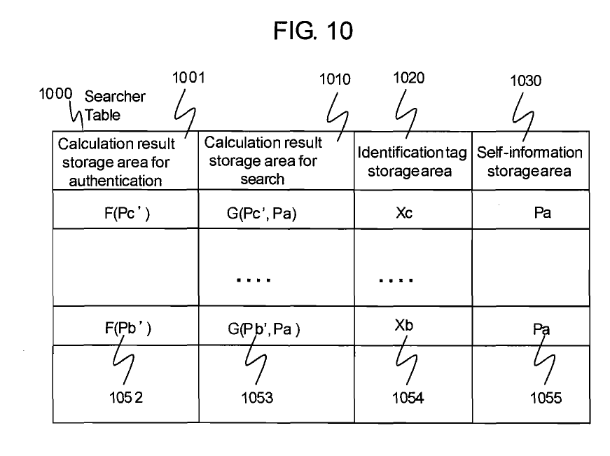

Next, the process in each step whereby the user A searches for the user B whose information is registered in the serve X is explained. The calculation device 401 of the information terminal 210 of the user A, who is the searcher of the user B, applies the aforementioned calculation G on the information Pb′ related to the user B stored in the storage device 405 and the information Pa related to the user A herself/himself and creates the calculation result G (Pb′, Pa). In addition, the user A applies the aforementioned calculation F on the information Pb′ related to the user B and obtains the calculation result F (Pb′) (Step S803). These calculation results G (Pb′, Pa) and F (Pb′) are stored in the searcher table 1000 in the storage device 405 by using table creation device 403 of the information terminal of user A (Step S804). An example of the searcher table 1000 is shown in FIG. 10. The searcher table 1000 includes a calculation result storage area 1001 for authentication, a calculation result storage area 1010 for search, an identification tag storage area 1020, and a self information storage area 1030. As shown in FIG. 10 in the present embodiment, the result F(Pb′) 1052 calculated by the aforementioned calculation F on the basis of the information Pb′, which is stored in the information terminal of the user A, related to the user B, who is to be searched, and the calculation result G (Pb′, Pa) 1053 is stored in the searcher table so that it is correlated with the information Pa 1055, which is an argument of G, related to the user A himself/herself. In this case, the information terminal 210 of the user A, who is the searcher, does not obtain the identification tag of the user B, who is to be searched and identified by the calculation result F(Pb′) and G(Pb′, Pa). Therefore, at this stage, a NULL value is stored in the storage area 1054 of the identification tag corresponding to these calculation results F(Pb′) and G(Pb′, Pa). As shown in FIG. 10, Xb 1054 is inserted into the searcher table in Step S808 explained later.

After that, the transmission/reception device 402 of the information terminal 210 of the user A, who is the searcher, transmits the aforementioned calculation result G(Pb′, Pa) for search to the server 200 via the network (Step S805). G(Pb′, Pa) is received by the transmission/reception device 301 of the server 200 of the service X. Then the search device 303 searches for the aforementioned calculation result G(Pb′, Pa), which is received from the terminal 210 of the user A in the aforementioned search table 900 which is stored in storage device 305. If it is detected by the search device 303 that the aforementioned calculation result G(Pb′, Pa) received from the information terminal 210 of the user A matches with the aforementioned calculation result G(Pb, Pa′) received in advance from the information terminal of user B (Step S806), then the transmission/reception device 301 of the server transmits the identification tag Xb stored and correlated with the aforementioned calculation result G(Pb, Pa′) to the terminal 210 of the user A who is the searcher. The condition where these calculation results are equal, i.e., G(Pb′, Pa)=G(Pb, Pa′), is that Pa=Pa′ and Pb=Pb′.

Next, the transmission/reception device 401 of the information terminal 210 of the user A, who is the searcher, receives the identification tag Xb of the user B from the server 200. The table creation device 403 inserts Xb into the searcher table 1000 so that the aforementioned calculation result G(Pb′, Pa) transmitted by the server 200 is correlated with Xb (Step S808). In Step S808, the identification tag Xb of the user B who is being searched, is inserted into the storage area 1054 corresponding to the aforementioned calculation result G(Pb′, Pa) of the searcher table 1000 shown in FIG. 10.

By the process of steps from Step S608 to Step S613, a user, who is to be searched, having the identification tag Xb, which is stored in the network service X, can be uniquely identified. At this stage, the user A does not obtain any evidence showing that this person who is searched is actually the user B, by using the information terminal 210. The evidence that the person who is searched is actually the user B, however, is obtained in Step S816 described later.

By using the following process, the authentication information is obtained expressing that person who is searched by the steps described above by the information terminal 210 of the user A, is actually the user B. The transmission/reception device of the terminal of the user A receives information from the server 200 in the above mentioned Step S808 and sends for obtaining the authentication the identification tag Xb of the user B, which is stored in the searcher table 1000, to the server 200 via the network (Step S809).

Next, the transmission/reception device 301 of the server 200 receives the identification tag Xb from the terminal 210 of the user A. Next, the search device 303 executes a search using the identification tag Xb received from the information terminal of the user A as a search key in the aforementioned authentication table 700 stored in the storage device 305 (Step S810). In the information terminal of the user B, if the steps for the authentication of the information Pb, which are explained in the explanation of Steps S601 to S604, are not executed, the calculation result F(Pb) correlated with Xb is not searched at step S810 (Step S811). In such a case, the user A cannot confirm that Pb′ stored in the information terminal 210 is the information related to the user B who is searched (Step S814). In the information terminal of the user B, if the steps for the authentication of the information Pb, which are explained in the explanation of Steps S601 to S604, are executed, the aforementioned calculation result F(Pb) correlated with Xb is searched (Step S811). In the search of the above mentioned Step S806, an identification tag is searched with the calculation result as a search key for the search table 900. On the other hand, in the search of Step S810, the calculation result is searched with the identification tag as a search key, for the authentication table 700, which is a so-called “reverse resolution.” When Xb is found in the authentication table in Step S811, the transmission/Reception device 301 of the server transmits the calculation result F(Pb) correlated with Xb, to the information terminal 210 of the user A, who is the searcher (Step S812).

Next, the transmission/reception device 402 of the information terminal 210 of the user A, who is the searcher, receives the calculation result F(Pb) transmitted by the server 200. Next, the calculation device 401 of the information terminal of the user A compares the calculation result for authentication F(Pb′) 1052 correlated with the identification tag Xb 1054 of the user B in the searcher table with the calculation result F(Pb) received by the server 200 (Step S813). If F(Pb)≠F(Pb′), Xb is not the identification tag of the user B or is not authenticated even if it is the identification tag of the user B (Step S815). When F(Pb′)=F(Pb) holds, it can be assured that the identification tag Xb of a person who is searched obtained by the information terminal 210 of the user A in Step S808 identifies the user B, where Pb is authenticated by the service Z (Step S816). The information terminal 210 of the user A can start the communication with the information terminal 220 by using identification tag Xb of the user B, only when it is authenticated (Step S817). The information terminal of the user A may use the identification tag Xb as a direct network address, to start the communication with the information terminal of the user B. Or a name resolution may be executed by referring to a database which correlates an identification tag with an IP address in a server and making the information terminal of the user A inquire the IP address correlated with the identification tag Xb to this server.

Furthermore, in the present embodiment, after obtaining the identification tag Xb correlated with the calculation result G(Pb′, Pa) from the search table in Step S806, the identification tag Xb is sent once to the information terminal of the user A in Step S807, and again in Step S809 this identification tag is sent to the server 200 for searching the authentication table. In the present embodiment, Step S809 may be omitted. In other words, in the server X 200 the identification tag Xb may be used in a reverse resolution of the authentication table 700 in Step S615, after obtaining the identification tag Xb of the user B by a search of the search table 900 in Step S806.

Next, some of the advantages of the procedure comprising steps from Step S800 to Step S808 of the present embodiment compared to the prior art are described below.

The first advantage of the present embodiment is that a user who is to be searched can specify the person who can search him/her in advance. In the present embodiment, the user B who is to be searched can be searched only by the user A, by registering G(Pb, Pa′) in the search table of the server in Step S802. Only the users who can create the calculation result G(Pb, Pa′) which is equal to this calculation result G (Pb, Pa′) can search the user B. The information terminal that can create this calculation result is only the information terminal that stores both the information Pb′ of the user B who is to be searched and the information Pa related to the searcher. There is a high possibility that such an information terminal is the information terminal of the user A, who knows user B. Of course, it is hard to exclude the case in which it is not the information terminal of the user A but of a third party who is spoofing the user A. However, there is no method to calculate G (Pb′, Pa) by the user who does not know the fact that the user B, who is to be searched, stores the information Pa′ related to user A, who is a searcher, in his/her information terminal nor the fact that the user B registers G (Pb, Pa′) in the server 200 according to the intention of the user B who permits the user A to search the user B. Therefore such a person cannot search the user B. There are several advantages of specifying the searcher in advance by a person who is to be searched as described in the present embodiment.

A second advantage of the present embodiment is that there is less possibility of acquiring unnecessary multiple search results by a search as compared to the prior art. The case where information Pb for search, registered in the server by the person who is to be searched, is the information such as a name, which is not necessarily searched uniquely on the network is considered here. For example, consider that the person who is to be searched registers the name ‘Smith’ in the server for search. In the prior art, multiple results of the user having the name “Smith” are found by the search of “Smith” executed by the searcher. However, in the present embodiment, a person named ‘Smith’ who is to be searched registers G (“Smith”, Brown”) in the server when Smith specifies ‘Brown’ as a searcher. This indicates that “Smith can be searched by Brown.” There is less possibility to acquire multiple search results in the present embodiment in which Smith, who permits Brown to search him, is searched than in the prior art in which “Brown” is searched.

A third advantage of the present embodiment is that an operator of the search service X can provide the search service without accessing the information related to a person who is to be searched. In the prior art, the information to be searched is stored in the storage device of the server that provides the search service so that the information can be accessed by the operator of the search service. In the present embodiment, information which is received by the server 200 providing the search service is not the information Pb related to B, who is to be searched, nor the information Pa′ related to user A, but the calculation result F(Pb) and G(Pb, Pa′). In the present embodiment, when the calculations F and G are irreversible calculations, it is hard for the operator of the search service X to restore the information related to the person who is to be searched and to access the information. However, if the calculations F and G are reversible, then the third advantage mentioned here is hard to obtain.

A fourth advantage of the present embodiment is as follows. As a consequence of the above advantages in which a person to be searched can be searched only by the searcher the person to be searched specifies, there are few cases where multiple search results are obtained, and the provider of the search service can not access the information related to the person to be searched, it is possible to realize a network service in which, as shown in FIG. 6, the process sequence in the information terminal of the user B, who is to be searched, and the process sequence in the information terminal of the user A who searches the user B are automatically executed without explicit consent of the user A and/or the user B. In this type of search service, a person to be searched need not manually register his/her information in the server, and acquaintances can be searched automatically and mutually on the network, even though the searcher does not carry out the search operation manually.

On the other hand, there may be two problems that are not easy to solve by the process of Step S800 to Step S808. The first problem is that it is hard to prevent the spoofing of a person who is to be searched by a malicious third person. The second problem is that it is hard to identify the person who is to be searched uniquely when calculation results are degenerated.

The first problem is described in detail below. As mentioned above, spoofing of a person who is to be searched by a malicious third person is difficult in the method of steps from Step S800 to Step S808 of the present embodiment as compared to the search method in the prior art. In the prior art, it is enough for a person who pretends to be a person who is to be searched to register only the information related to the person who is to be searched in the server for a search. On the other hand, in the example shown in the above mentioned steps from Step S800 to Step S808, a person who pretends to be a person to be searched requires the information related to a searcher whom the person to be searched permits to search himself/herself in addition to the information related to the person to be searched. In the present embodiment, if the calculation result of information related to a person to be searched and the searcher is not registered in the server, spoofing of a person who is to be searched is not easy.

It is not, however, always a case where the information related to a person who is to be searched and searcher is kept confidential. Moreover, by using any automatic technique, the information related to the searcher and person who is to be searched can be generated. Therefore, it is not easy to prevent the spoofing of a person who is to be searched by a malicious third person completely even if the process of steps from Step S800 to Step S808 of the present embodiment is used. For example, in the aforementioned Step S802, the information terminal of the user B, who is to be searched, creates the calculation result G(Pb, Pa′) and registers it in the server 200. However, P(Pb′, Pa′) can be created in an information terminal of a third person which stores information Pa′ of the user A and information Pb′ of user B even if such an information terminal is not the information terminal of the user B. For example, a malicious third person C may register to the search table 900 after correlating information Pa related to the user A and P(Pb′, Pa′) from user Pb′ with the identification tag Xc of the user C in the terminal. In this case, when the information terminal of the user A transmits P(Pb′, Pa) to the server X in Step S805, the identification tag Xb is not transmitted in Step S807 but the identification tag Xc is transmitted since P (Pb′, Pa′)=P (Pb′, Pa′) holds. This is so called spoofing but it is not easy to prevent it completely by the process of steps from Step S800 to Step S808.

The second problem is described in detail below. In the example shown in the present embodiment, an irreversible calculation is used as calculations F and G. Among irreversible calculations used generally, there is a hash operation such as MD-5 or SHA-1. In such a calculation, there is a possibility in which the same calculation result may be obtained for different inputs. This is called a degeneration of a calculation result for input. In such a case where a calculation result is degenerated, for example, an identification tag other than that of the user B may be correlated with the calculation result having a value equal to the calculation result G(Pb′ Pa) in the aforementioned search table. In this case, the user B, who is to be searched, can not be uniquely identified since multiple different results may be obtained by the search of the aforementioned Step S806.

The first and second problems are solved by the combination of the aforementioned Steps from S800 to S808 and the aforementioned Step S809 to S816. It is an additional advantage of the present embodiment.

The fifth advantage of the present embodiment is that it is possible to prevent spoofing of a person, who is to be searched, by a malicious third person. In Step S601, it is authenticated that the information Pb stored in the information terminal of the user B is the information related to the user B and in Step S604 F(Pb) is stored in the authentication table 700 of the server 200 so that it is correlated with the identification tag Xb. In the above mentioned Step S813, if F(Pb) is obtained as a result of the reverse resolution where the authentication table is searched by Xb as a search key in Step S810, it means that the information Pb correlated with the identification tag Xb is the information of the user B. Accordingly, if the information F(Pb′) in the searcher table 1000 and F(Pb) obtained from the server X200 in Step S813 are the same, then the user A can know that Pb′ stored in the terminal of the user A is the information related to the user B.

For example, as mentioned above, the case where a malicious third person C registers P(Pb′, Pa′) in the search table 900 so that P(Pb′, Pa′) is correlated with identification tag Xc of user C, is considered. As for the user C, since Pb′ is not authenticated as the information related to the user C in Step S601, F(Pb′) can not be inserted in the authentication table 700 so that it is correlated in Step S604 with the identification tag Xc. What the user C can insert into the authentication table 700 to correlate with the identification tag Xc is F(Pc) where the information Pc is related to the user C. Here, when the user A, who is a searcher, sends G(Pb′, Pa) to the server X for searching the user B in Step S805, since P (Pb′, Pa′)=G (Pb′, Pa) holds, the information terminal of the user A in Step S808 stores the identification tag Xc in the identification tag storage area 1054 in the searcher table as an identification tag of the user B. At this point, spoofing of the user B by the user C seems to be successful. However, in Step S810, the information terminal of the user A searches the authentication table 700 by using the identification tag Xc as a search key. In Step S812, what is received from the server in Step S812 is F(Pc) as a result of the information correlated with Xc in Step S812. When a comparison in Step S813 is executed, since F(Pb′)≠F(Pc), the user A knows that Xc is not the identification tag of user B (Step S815). Thus, spoofing by the malicious third person C fails by using the process from Step S809 to Step S816. Furthermore, at this time also, the first, second, and third advantages are effective.

The sixth advantage of the present embodiment is that, for example, even when a calculation result is degenerated as a hash calculation may be, it is easy to specify the person who is to be searched uniquely. For example, consider that a hash calculation is used as calculations F and G. The condition for identifying the user B, who is to be searched by user A, who is a searcher, is G (Pb′, Pa)=G (Pb, Pa′) according to the process from Step S800 to Step S808. Since the hash operation is degenerated in this case, at a fixed probability α (0<α<1), there exists a calculation result registered from the information terminal other than that of the user B and the calculation results happens to be equal to G (Pb′, Pa). In this case, the searcher A can not identify the user B, who is to be searched, uniquely.

However, in Steps from Step S809 to Step S816, the condition for confirming that the information Pb′ which the information terminal of the user A stores is the information related to the user B is authenticated is F(Pb′)=F(Pb). However, since the hash operation is degenerated, at a certain probability β (0<β<1), there exists a calculation result registered from the information terminal other than that of the user B and the calculation result is equal to F (Pb′).

As mentioned above, in the method of the present embodiment, the condition for the user B to be searched by the user A is G(Pb′, Pa)=G(Pb, Pa′) and F(Pb′)=F(Pb). In other words, for example, even though the calculations G and F are degenerated, in the method of the present embodiment, the probability to find a user who is not the person as the person who is being searched by user A is α∴β. Generally, since α and β are small values in a hash operation, the product of α×β is much smaller, and as compared to the process from steps from S1003 to S1004, it is easy to identify the person who is being searched uniquely. Of course, when the calculation G and/or the calculation F is not degenerated, in other words, when α=0 and/or β=0, the person who is being searched is searched uniquely.

### Embodiment Two

In the embodiment one explained above, the information terminal of the user A searches the user B by using the information Pb′ and the fact that the information Pb′ is authenticated to be the information related to user B is obtained after obtaining an identification tag Xb by which the user B is identified uniquely. This can be regarded as a process of one way search where the user A searches for the user B.

In the embodiment two of the present invention, a process is explained where communication is started after the user A searches for the user B, the user B searches for the user A one after another or simultaneously, and then the information related to each other is authenticated at each side. In the embodiment two, both the user A and the user B are the searchers as well as the persons to be searched. In the present embodiment also, similar to the embodiment one, the server X 200, the information terminal 210 of the user A and the information terminal 220 of the user B are connected via a network as shown in FIG. 2. Furthermore, each schematic configuration diagram of the server X 200, the information terminal 210 of the user A and the information terminal 220 of the user B is as shown in FIG. 3, FIG. 4 and FIG. 5.

In the present embodiment, the authentication of the information related to a person who is to be searched and the registration to the authentication table (from Step S601 to Step S604) need not be performed before the search by a searcher. This is one of the differences between the embodiment one and the embodiment two.

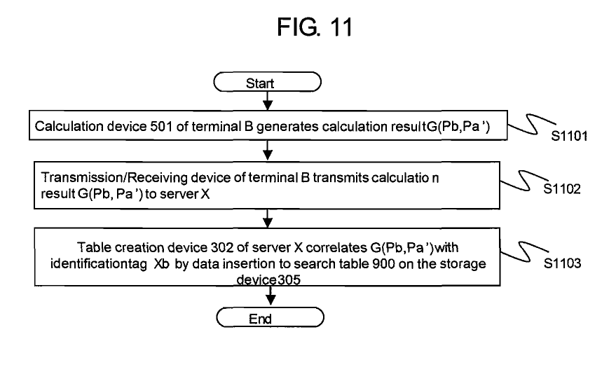

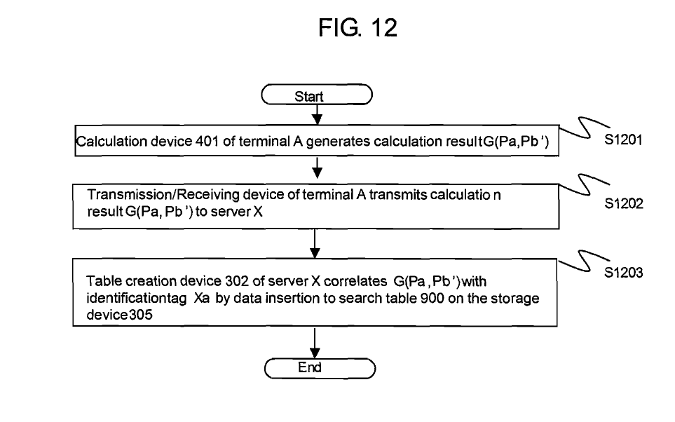

FIG. 11 is a flow chart explaining the process for searching for the user B by the user A. FIG. 12 is a flow chart explaining the process for searching for the user A by the user B.

Referring to FIG. 11, the first calculation device 501 of the information terminal of the user B creates the calculation result G (Pb, Pa′) from self related information Pb, stored in the storage device 505, and the information Pa′ related to the user A (Step S1101). After that, the transmission/reception device 501 of the information terminal of the user B transmits the above mentioned calculation result G(Pb, Pa′) to the server X 200 (Step S1102). Then, the table creation device 302 of the server X inserts G (Pb, Pa′) to the search table 900 in the storage device so that G (Pb, Pa′) is correlated with the identification tag Xb of the user B. This corresponds to the permission of the user B for the user A to search for the user B registered to the server 200.

Referring to FIG. 12, the calculation device 401 of the information terminal of the user A creates the calculation result G (Pa, Pb′) from the information Pa related to himself/herself which is stored in the storage device 405 and the information Pb′ related to user B (Step S1201). After that, the transmission/reception device 402 of the information terminal of the user A transmits the aforementioned calculation result G (Pa, Pb′) to the server X200 (Step S1202). After that, the table creation device 302 of the server X inserts it to the search table 900 on the storage device so that G(Pa, Pb′) is correlated with the identification tag Xa of the user A. This corresponds to user A where he can be searched by a user and it is registered in server 200.

The aforementioned calculation G may be reversible or irreversible. In the explanation below, the calculation G is assumed to be non-commutative and irreversible as an example. As an example of a non-commutative and irreversible calculation, there is an operation to calculate its hash value after concatenating character strings. However, the aforementioned calculation G may be a commutative or non-commutative calculation. In the example shown in the present embodiment, it is a non-commutative calculation and information Pb related to a person who is to be searched is given as a first argument of G and the information Pa′ related to a searcher is given as a second argument of G. Of course the order may be reversed. However, here, Pb and Pa′ which are the arguments of the calculation G need not be information of the same attributes. For example, Pb may be the name of the user B, and Pa′ may be the e-mail address of the user A. Moreover, the calculations F and G may be the same, or they may be different calculations.

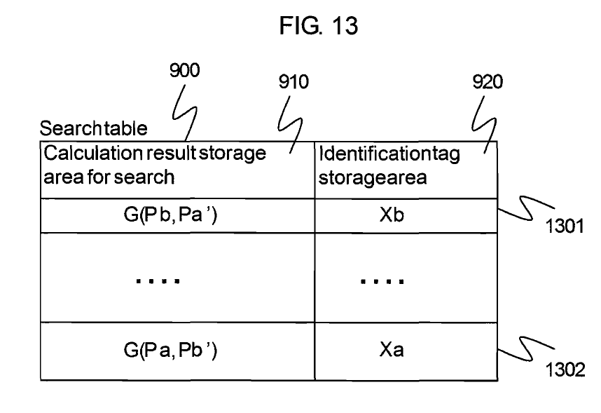

The preparation process for searching the user B by the user A shown in FIG. 11 and the preparation process for searching the user A by the user B shown in FIG. 12 may be executed one after another or simultaneously. For example, if each step shown in FIG. 11 and each step shown in FIG. 12 are executed, the search table becomes as shown in FIG. 13. FIG. 13 shows the status of the search table that contains the pair of Xb and G(Pb, Pa′) inserted as a row 1301 by the steps shown in FIG. 11 and a pair of Xa and G(Pa, Pb′) inserted as a row 1302 by steps shown in FIG. 12.

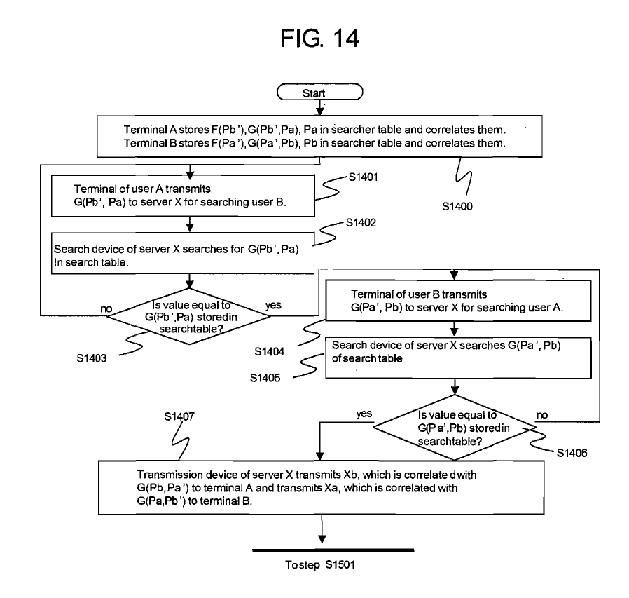

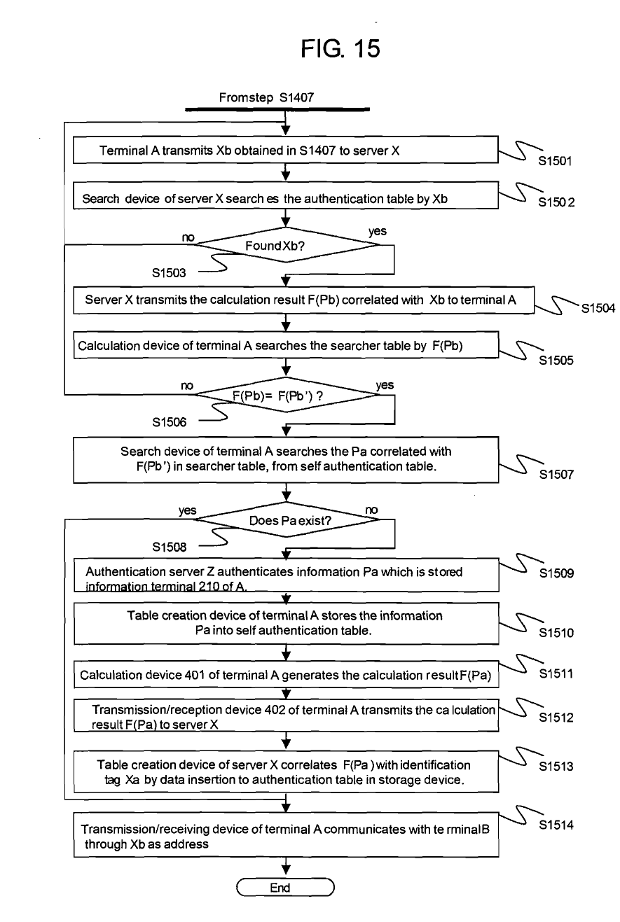

Next, in the present embodiment, the information terminal 210 of the user A and the information terminal 220 of the user B mutually search each other in the server X. Steps to start mutual communication after confirming that the identification tag of a person, who is to be searched, obtained as each search result is the person himself/herself, who is searched are explained with reference to the flow chart in FIG. 14 and FIG. 15.

Firstly, the information terminal of the user A executes the following process to search the information terminal of the user B. The calculation device 401 of the information terminal of the user A creates the calculation result G(Pb′, Pa) by applying G on the information Pb′ and the information Pa stored in the storage device 405; and the table creation device 403 stores it in the calculation result storage area 1010 for search of the searcher table 1000. Moreover, based on this calculation, the calculation result G(Pb′, Pa) is stored in the self information storage area 1030 so that it is correlated the information Pa related to the user A himself/herself. In addition, the calculation device 401 creates the calculation result F(Pb′) by using the information Pb′ stored in the storage device 405, and the table creation device 403 stores it in the calculation result storage area 1001 for authentication of the searcher table 1000 so that it is correlated with the aforementioned G (Pb′, Pa) and Pa. The reference numerals 1053, 1055, and 1052 shown in FIG. 10 are G (Pb′, Pa), Pa, and F(Pb′), which are stored here, respectively. Similarly, the information terminal of the user B executes the following process to search the information terminal of the user A by using the process of the present embodiment. Firstly, the calculation device 501 of the information terminal of the user B creates the calculation result G(Pa′, Pb) by applying G on the information Pa′ and Pb stored in the storage device 505 and the table creation device 503 stores it in the calculation result storage area for search of the searcher table 1009. Moreover, based on this calculation, the information Pb related to the user B himself/herself is stored in the self information storage area of the searcher table 1009 so that it is correlated with calculation result G(Pa′, Pb). In addition, the calculation device 501 creates the calculation result F(Pa′) by applying F on the information Pa′ stored in the storage device 505 and the table creation device 403 stores it in the calculation result storage area for authentication of the searcher table 1009 so that it is correlated with the aforementioned G (Pa′, Pb) and Pb (Step S1400).

Next, the transmission/reception device 402 of the information terminal of the user A sends the aforementioned calculation result G(Pb′, Pa), which is stored in the searcher table 1000, to the server X 200 for searching the information terminal of the user B (Step S1401). After that, the search device 303 searches the search table 900 with G(Pb′, Pa) as a search key after the transmission/reception device 301 of the server X receives the aforementioned calculation result G (Pb′, Pa) (Step S1402). At this stage, if Step S1103 of FIG. 11 is not completed or if G(Pb′, Pa)≠G(Pb, Pa′), the process proceeds to the branch of ‘NO’ of Step S1403 and returns to Step S1401. In the case where Step S1402 is executed after completing Step S1103 of FIG. 11 and G(Pb′, Pa)=G(Pb, Pa′) holds, the process proceeds to the branch of ‘YES’ of Step S1403 and proceeds to the next Step S1404.

After that, the transmission/reception device 502 of the information terminal of the user B sends the aforementioned calculation result G(Pa′, Pb), which is stored in the searcher table 1009, to the server X 200 for searching the information terminal of the user A (Step S1404). After that, the search device 303 searches the search table 900 with this G (Pa′, Pb) as a search key after the transmission/reception device 301 of the server X receives the aforementioned calculation result G (Pa′, Pb) (Step S1405). When Step S1203 of FIG. 12 is not completed or if G(Pa′, Pb)≠G(Pa′, Pb), the process proceeds to the branch of ‘NO’ of Step S1406 and returns to the Step S1404. In the case where Step S1405 is executed after completing Step S1203 of FIG. 12 and G(Pa′, Pb)=G(Pa, Pb′) holds, the process proceeds to the branch of ‘YES’ of Step S1406 and proceeds to the next Step S1407.

In other words, when the following two conditions are fulfilled, the process proceeds to Step S1407. The first condition is, the calculation result G(Pb, Pa′) which indicates that the information terminal of the user B can be searched by the user A in Step S1103 should be registered in the search table of the server X and G(Pb′, Pa) searched by the information terminal of the user B in Step S1402 should be equal to G (Pb, Pa′). The second condition is, the calculation result G(Pa, Pb′) which indicates that the information terminal of the user A can be searched by the user B in Step S1203 should be registered in the search table of the server X and G (Pa′, Pb) searched by the information terminal of the user B in Step S1404 should be equal to G (Pa, Pb′).

Next, the transmission/reception device 301 of the server X transmits the identification tag Xb correlated with G(Pb, Pa′) in the search table 900 to the terminal 210 of the user A which transmits the search query in Step S1401. In addition to that, the communication device 301 of the server X transmits the identification tag Xa correlated with G(Pa, Pb′) in the search table 900 to the information terminal 220 of the user B which transmits the search query in Step S1404. (Step S1407).

Next, the information terminal 210 of the user A executes each step shown in FIG. 15 and starts the communication with the information terminal 220 of the user B. Further, in FIG. 15, the process explains the steps until the information terminal 210 of the user A uses the identification tag Xb of the user B and the communication with the information terminal 220 is started. After Step S1407, by the process corresponding to FIG. 15, the information terminal 220 of the user B uses the identification tag Xa of the user A and the communication with the information terminal 210 is started. That is, the latter process is symmetric with A and B in the description of the former process with reference to FIG. 15 and a description of the latter process is omitted since the latter processing is essentially equivalent to the former processing.

Next, referring to FIG. 15, the process of the present embodiment is described below in which the information terminal 210 of the user A searches the information terminal 220 of the user B and the communication with each other is started after confirming both the user A and the user B.

First, at Step S1501, the transmission/reception device 402 of the information terminal of the user A transmits the identification tag Xb, which is obtained from the server X at the aforementioned Step S140, to server X. The objective of this transmission of Xb to the server is to enquire to the server X whether Xb is actually the identification tag of the user B. If the transmission/reception device 301 of the server X receives this identification tag Xb, the search device 303 searches the authentication table 700 with the identification tag Xb as a search key (Step S1502) and if it is not found in the identification tag storage area 720 of the authentication table 700, the aforementioned Step S1501 and Step S1502 are repeated until it is found (Step S1503)

When it is found, the transmission/reception device 301 of the server X transmits the calculation result F(Pb) correlated with Xb in the authentication table 700 to the information terminal 210 of the user A (Step S1504). After that, the transmission/reception device 402 of the information terminal of the user A receives the calculation result F(Pb) and the search device 404 searches the calculation result storage area 1001 for authentication of the searcher table with F(Pb) as a search key (Step S1505). Only if in the previous Step S1401,the calculation result F(Pb′) is registered in the calculation result storage area 1001 for authentication of the searcher table and F(Pb′), which is registered, and F(Pb), which is received by the server X in Step S1505, are equal, the process proceeds to the next Step S1507 (Step S1506). If it is not the case, the process returns to Step S1501.

Step S1507 is the process in which the information terminal 210 of the user A confirms that the information terminal 220 of the user B belongs to the user B. When it is confirmed, the process proceeds to Step S1507.

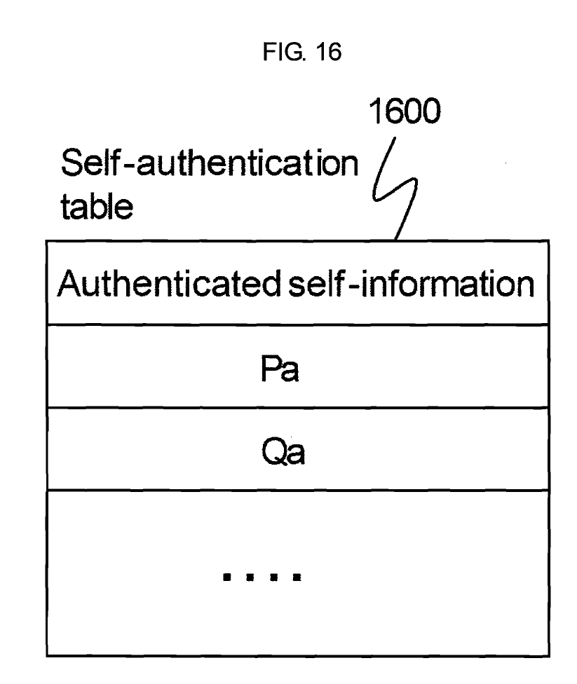

Next, the search device 404 of the information terminal of the user A decides by searching whether the aforementioned F(Pb′) 1052 in the searcher table 1000 and the identification tag Pa of the user A correlated with Xb 1054 exists in the self authentication table 1600. The self authentication table 1600 stores only the information authenticated by the authentication server Z, which indicates that information related to the user A stored in the storage device 405 is of the user A himself/herself. FIG. 16 shows an example of the self authentication table in the present embodiment.

If the information terminal 210 of the user A executes the process shown in FIG. 14 and FIG. 15 at the first time, in other words, if Step S1510 has never been completed, the information Pa does not exist in the self authentication table 1600. However, if Step S1510 has been executed by the information terminal of the user A, Pa exists in the self authentication table 1600.

If Pa exists in the self authentication table in the search at the aforementioned Step S1507, the process proceeds to the branch of ‘YES’ of Step 1508 and proceeds to Step S1514. In other words, after the confirmation of the user A and the user B by each other, the information terminal 210 of the user A starts communication with the information terminal 220 of the user B on the basis of the identification tag Xb of the user B.

If Pa does not exist in the self authentication table in the search at the aforementioned Step S14507, the information Pa of the user A is not yet authenticated by the server Z. In such a case, the process proceeds to the branch of ‘No’ of Step S1508 and proceeds to Step S1509.

Next, the authentication server Z authenticates that the information Pa in the information terminal 210 belongs to the user A himself/herself (Step S1509). Any method of authentication can be used regardless of method or level of authentication, similar to Step S601 in the embodiment one. The server Z may authenticate that the information Pa belongs to the user A by using face to face authentication, the user A may exchange e-mails with the server Z by the information terminal 210, or the authentication by a Turing test, such as transmitting a string provided by CAPTCHA to server Z may also be used.

When the information terminal 210 of the user A obtains from the server Z the information that the information Pa is authenticated by the authentication server Z, the table creation device 403 of the information terminal of the user A registers the information Pa as authenticated information in the self authentication table 1600 (Step S1510).

Next, the calculation device 401 of the information terminal of the user A creates the calculation result F(Pa) (Step S 511) and the transmission/reception device 402 transmits it to the server X (Step S1512). The calculation F may be reversible or irreversible. In the present embodiment, the calculation F is assumed to be an irreversible calculation. The table creation device 302 of the server, which has received the calculation result F(Pa), stores it in the authentication table 700 so that it is correlated with the identification tag Xa of the user A (Step S1013). According to the process in the above steps from S1509 to S1513, the information related to the user A is authenticated by the server Z and then it is inserted into the authentication table of the server X. Since the process has proceeded to the branch of ‘YES’ of the aforementioned Step S1506, the information terminal 210 of the user A has already obtained the fact that the information Pb, related to the user B who is going to communicate with the user A, is authenticated by the server Z. Hence, the information terminal 210 of the user A is assured, at Step S1513, that both the information Pb related to the user B and the information Pa related to the user A himself/herself is authenticated. Then, the information terminal of the user A starts the communication with the information terminal 220 of the user B by using the identification tag Xb of the user B obtained at Step S1407.

Next some of the advantages of the present embodiment as compared with the prior art are described. Advantages one to six of the aforementioned embodiment one are also effective in the present embodiment. The following are the advantages of the present embodiment obtained in addition to the advantages of the embodiment one.

The seventh advantage is that when the user A and the user B search each other, they need not have information related to them authenticated before the search. The user A and the user B can search each other also by using the process explained in the embodiment one. However, in the processing of the embodiment one, both the user A and the user B have to be authenticated and have to register the calculation results to the authentication table shown in FIG. 6 before the search in order to start communication with confirmation that a third person is not spoofing mutually. On the other hand, according to the method of the present embodiment, the registration of calculation results to the authentication table and the authentication shown in steps from S1509 to S1513 may be executed after completion of a mutual search shown in FIG. 14.

As to the seventh advantage, the aforementioned advantages from one to six are effective even if the order of the authentication and the search is changed in the present embodiment. From the view point of information process, such change of order seems not to make much difference at the first glance. It has, however, much significance in actual use. The reason for this is that the user operation is necessary for authentication from the identification purposes. In the method of the embodiment one, where the authentication is executed before a search, the user can get the benefit of “search is possible” by paying the costs of the user operation in the authentication process. However, in the present embodiment, in which the authentication is performed after the completion of a search of an information terminal of a user to be communicated with, by paying a user operation cost, a user gains “communication is possible with the terminal of the user who is found in a search.” For a user, the motivation for authentication associated with operation is higher for the latter than for the former.

According to a system, a method, a computer program, a sever, an information terminals, an operating system, a middleware, an information and communication equipment, an authentication method, a system and an application software related to the embodiments of the present invention, even if an explicit search is not conducted, acquaintances can be searched, and the person who is to be searched can restrict the scope of the searchers on the network in advance. Further, there are fewer cases in which unnecessary multiple search results are obtained. Moreover, it is not necessary for a person who is to be searched to disclose the information even to the administrator of the server. Further, spoofing by a malicious third party can be realized. Consequently, for example, in the present invention, the person who is to be searched can be safely searched using his/her real name.

What is claimed is:

1. An information terminal comprising:
a storage device which stores information Pb related to an owner of the information terminal and information Pa′ related to a user different from the owner;
a calculation device for calculating a calculation result G(Pa′, Pb) by applying a calculation G to the information Pb and the information Pa′ stored in the storage device; and
a transmitting device which transmits the calculation result G(Pa′, Pb) to a server.

2. An information terminal comprising:
a calculation device for calculating a calculation result F(Pb) by applying a calculation F to the information Pb related to an owner of the information terminal and stored in the information terminal;
a receiving device which receives trust information which expresses that the information Pb is related to the owner of the information terminal is authenticated; and
a transmitting device which transmits the calculation result F(Pb) to a server when the receiving device receives the trust information.

3. An information terminal comprising:
a storage device which stores information Pa relating to an owner of the information terminal and information Pb′ relating to a user different from the owner;
a first calculation device for calculating a calculation result G(Pb′, Pa) by applying a calculation G on the information Pa and the information Pb′ stored in the storage device;
a second calculation device for calculating a calculation result F(Pb′) by applying a calculation F to the information Pb′; and
a table creation device for correlating the calculation result G(Pb′, Pa) with the calculation result F(Pb′).

4. The information terminal according to claim 3, wherein the table creation device which correlates the information Pa in addition to G(Pb′, Pa) with F(Pb′).

5. A server comprising:
a receiving device which receives from an information terminal of a user B a calculation result G (Pa′, Pb), which is calculated by applying a calculation G to information Pb relating to user B stored in the information terminal of the user B, and information Pa′ relating to a user A, the information Pa′ being stored in the information terminal of user B; and
a table creation device for correlating the calculation result G (Pa′, Pb) with an identification tag Xb for uniquely specifying the user B.

6. The server according to claim 5, further comprising:
a second receiving device which receives from an information terminal of the user A a calculation result G(Pa, Pb′), which is calculated by applying the calculation G to information Pa relating to the user A stored in the information terminal of user A, and information Pb′ relating to user B stored in the information terminal of user A; and
a searching device which searches the table by using the calculation result G(Pa, Pb′) as a search key, and obtains as a search result the identification tag Xb which is correlated with the calculation result G(Pa′, Pb) when a match between the calculation result G (Pa, Pb′) and the calculation result G (Pa′, Pb) is detected.

7. The server according to claim 6, further comprising:
a transmitting device for transmitting the identification tag Xb obtained as the search result, to the information terminal of user A.

8. A server comprising:
a first receiving device which receives trust information which expresses that information Pb stored in an information terminal is authenticated to be information of an owner of the information terminal;
a second receiving device which receives a calculation result F(Pb) calculated by applying a calculation F to Pb stored in the information terminal and transmitted to the server by the information terminal, on the reception of the trust information by the first receiving device; and
a table creation device which stores an identification tag Xb for uniquely specifying user B and the calculation result F(Pb) and correlates F(Pb) with Xb.

9. The server according to claim 8, further comprising:
a receiving device which receives the identification tag Xb from another information terminal of another owner A;
a search device which searches the table for the identification tag Xb as a search key; and
a transmitting device which transmits to the information terminal of the owner A the calculation result F(Pb) obtained as a search result when a searching device searches the table for the received identification tag Xb as a search key.

10. A server comprising:
a first receiving device which receives a calculation result G(Pa′, Pa) from an information terminal of a user B, the calculation result being calculated by applying a calculation G to information Pb relating to the user B and information Pa′ relating to a user A stored in the information terminal of the user B;
a first table creation device which stores an identification tag Xb for uniquely specifying the user B and the calculation result G(Pa′, Pb) in a first table and correlating G(Pa′, Pb) with Xb;
a second receiving device which receives trust information from the information terminal of the user B, the trust information showing that the information Pb stored in the information terminal of the user B belongs to the user B is authenticated;
a third receiving device which receives a calculation result F(Pb) transmitted after the second receiving device receives the trust information; and
a second table creation device which stores the identification tag Xb for uniquely specifying user B and the calculation result F(Pb) in a second table and correlates F(Pb) with Xb.

11. An information terminal comprising:
a transmitting device which transmits an identification tag Xb for uniquely specifying a user B to a server, the user B being different from an owner of the information terminal;
a first receiving device which receives trust information which expresses that information Pb stored in the information terminal of the user B is authenticated as information relating to the user B; and
a second receiving device which receives via the server a transmitted calculation result F(Pb) calculated by applying a calculation F to the information Pb, when the first receiving device receives the trust information.

12. A system comprising:
an information terminal of a user A which stores information Pa relating to the user A and information Pb′ relating to a user B;
an information terminal of a user B which stores information Pa′ relating to the user A and information Pb relating to the user B; and
a server;
wherein the information terminal of the user B comprises:
a first transmitting device which transmits a first calculation result G(Pb, Pa′) to the server; the first calculation result being calculated by applying a calculation G to the information Pa′ of the user A and the information Pb of the user B;
wherein the information terminal of the user A comprises:
a second transmitting device which transmits a second calculation result G(Pb′, Pa) to the server, the second calculation result being calculated by applying a calculation G to the information Pa of the user A and the information Pb′ of the user B; and
wherein the server comprises:
a storage device which stores the first calculation result G(Pb, Pa′) and an identification tag Xb of the user B and correlates G(Pb, Pa′) with Xb;
a third transmitting device which transmits the identification tag Xb of the user B to the information terminal of the user A when the identification tag Xb of the user B is detected to be correlated with the first calculation result G(Pb, Pa′) by searching for a calculation result which matches with the second calculation result G(Pb′ Pa) and detecting a match between the first calculation result G (Pb, Pa′) and the second calculation result G (Pb′, Pa).

13. A system comprising:
an information terminal of a user B which stores information Pb of the user B; and
a server;
wherein the information terminal of the user B comprises:
a receiving device which receives trust information which expresses that the information Pb stored by the information terminal of the user B belongs to the user B is authenticated; and
a transmitting device which generates a calculation result F(Pb) by applying a calculation F to the information Pb stored in the information terminal of the user B and transmits the calculation result F(Pb) to the server when the receiving device receives the trust information; and
the server comprises a storage device which stores the calculation result F(Pb) and an identification tag Xb of the user B and correlates F(Pb) with Xb.

14. A system comprising:
an information terminal of a user A which stores information Pa relating to the user A and information Pb′ relating to a user B;
an information terminal of the user B which stores information Pa′ relating to the user A and information Pb relating to the user B; and
a server;
wherein the information terminal of the user B comprises:
a receiving device which receives trust information which expresses that the information Pb belongs to user B is authenticated;
a first transmitting device which generates a first calculation result F(Pb) by applying a calculation F to the information Pb and transmits the first calculation result F(Pb) to the server when the receiving device receives the trust information; and
a second transmitting device which generates a second calculation result G(Pb, Pa′) by applying a calculation G on the information Pa′ relating to the user A and the information Pb relating the user B;
wherein the information terminal of user A comprises:
a third transmitting device which generates a third calculation result G(Pb′, Pa) which is calculated by applying a calculation G on the information Pa relating to the user A and the information Pb′ relating to the user B and transmits the third calculation result to the server;
wherein the server comprises:
a first storage device which stores in a first table the first calculation result F(Pb) and an identification tag Xb of the user B and correlates F(Pb) with Xb;
a second storage device which stores in a second table the second calculation result G(Pb, Pa′) and the identification tag Xb of the user B and correlates G(Pb), Pa′) with Xb;
a search device which searches the second table for a calculation result which matches the third calculation result by detecting a match between the second calculation result G(Pb, Pa′) and the third calculation result G(Pb′, Pa), detecting the identification tag Xb correlated with the second calculation result, searching the first table for the identification tag Xb as a search key and detecting the first calculation result F(Pb); and
a transmitting device which transmits the first calculation result F (Pb) to the information terminal of user A.

15. A system comprising:
an information terminal of a user A which stores information Pa relating to the user A and information Pb′ relating to a user B;
an information terminal of the user B which stores information Pa′ relating to the user A and information Pb relating to the user B; and
a server;
wherein the information terminal of the user B comprises:
a first transmitting device which generates a first calculation result G(Pb, Pa′) which is calculated by applying a calculation G on the information Pa′ and the information Pb and transmits the first calculation result to the server;
a second transmitting device which generates a second calculation result G(Pa′, Pb) which is calculated by applying the calculation G on the information Pa′ and the information Pb and transmits the second calculation result to the server;
a first receiving device which receives first trust information which expresses that the information Pb belongs to user B is authenticated; and
a third transmitting device which transmits a third calculation result F (Pb) to the server when the first receiving device receives the first trust information;
wherein the information terminal of the user A comprises:
a fourth transmitting device which generates a fourth calculation result G(Pa, Pb′) which is calculated by applying the calculation G on the information Pb′ and the information Pa and transmits the second calculation result to the server;
a fifth transmitting device which generates a fifth calculation result G(Pb′, Pa) which is calculated by applying the calculation G on the information Pa and the information Pb′ and transmits the fifth calculation result G(Pb′, Pa) to the server;
a second receiving device which receives second trust information which expresses that the information Pa belongs to user A is authenticated;
a sixth transmitting device which transmits a sixth calculation result F(Pa) to the server when the second receiving device receives the second trust information;
wherein the server comprises:
a first storage device which stores in a first table an identification tag Xb of the user B and the first calculation result G(Pb, Pa′), correlates G(Pb, Pa′) and Xb, stores in the first table an identification tag Xa of the user A and the fourth calculation result G(Pa, Pb′), and correlates G(Pa, Pb′) with Xa;
a detection device which searches the first table for the fifth calculation result G (Pb′, Pa) as a search key, detects a match with the first calculation result G (Pb, Pa′), detects the identification tag Xa of the user A correlated with the first calculation result G (Pb, Pa′) in the first table, searches the first table for the second calculation result G (Pa′, Pb) as a search key, detects a match with the fourth calculation result G (Pa, Pb′), and detects the identification tag Xb of the user B correlated with the first calculation result G (Pb, Pa′) in the first table;
a correlating device which stores the sixth calculation result F(Pa) and the identification tag Xa of the user A, correlates F(Pa) with Xa, stores the third calculation result F(Pb) and the identification tag Xb of the user B, and correlates F(Pb) with Xb.

16. The information terminal according to claim 1, wherein the calculation G is irreversible.

17. The server according to claim 5, wherein the calculation G is irreversible.

18. The system according to claim 12, wherein the calculation G is irreversible.

19. The information terminal according to claim 2, wherein the calculation F is irreversible.

20. The information terminal according to claim 3, wherein the calculations G and F are irreversible.

21. The server according to claim 8, wherein the calculation F is irreversible.

22. The server according to claim 10, wherein the calculations G and F are irreversible.

23. The information terminal according to claim 11, wherein the calculation F is irreversible.
